(19) United States
(12) Patent Application Publication
(10) Pub. No.: US 2002/0087307 A1
(43) Pub. Date: Jul. 4, 2002

(54) Computer-implemented progressive noise scanning method and system

(76) Inventors: Victor Wai Leung Lee, Waterloo (CA); Otman A. Basir, Kitchener (CA); Fakhreddine O. Karray, Waterloo (CA); Jiping Sun, Waterloo (CA); Xing Jing, Waterloo (CA)

Correspondence Address: John V. Biernacki, Esq., Jones, Day, Reavis & Pogue, North Point, 901 Lakeside Avenue, Cleveland, OH, 44114, US

(21) Appl. No.: 09/863,940

(22) Filed: May 23, 2001

Related U.S. Application Data
(60) Provisional application No. 60/258,911, filed on Dec. 29, 2000.

(51) Int. Cl. G10L 15/20; G10L 15/00

(52) U.S. Cl. 704/233

(57) ABSTRACT

A computer-implemented method and system for speech recognition of a user speech input. The user speech input contains a request that needs processing. A first noise probability model is applied to the user speech input at a first noise ratio level in order to recognize a first set of words in the user speech input. A second noise probability model is applied to the user speech input at a second noise ratio level in order to recognize a second set of words in the user speech input. The user's request is processed based upon which words are recognized in both the first set and second set of recognized words.

### RELATED APPLICATION

This application claims priority to U.S. provisional application Serial No. 60/258,911 entitled “Voice Portal Management System and Method” filed Dec. 29, 2000. By this reference, the full disclosure, including the drawings, of U.S. provisional application Serial No. 60/258,911 are incorporated herein.

### FIELD OF THE INVENTION

The present invention relates generally to computer speech processing systems and more particularly, to computer systems that recognize speech.

### BACKGROUND AND SUMMARY OF THE INVENTION

Speech recognition systems are increasingly being used in telephony computer service applications because they are a more natural way for information to be acquired from people. For example, speech recognition systems are used in telephony applications where a user through a communication device requests that a service be performed. The user may be requesting weather information to plan a trip to Chicago. Accordingly, the user may ask what is the temperature expected to be in Chicago on Monday.

A traditional speech recognition system regards noise as part of the waveforms in an input utterance. Noise is usually detected and eliminated with fixed probabilities. This means that speech-to-noise ratio is fixed and pre-defined in acoustic models. With fixed ratio, the traditional method becomes difficult to detect noise from speech, especially on a variety of background noise with different speaker accents. The present invention overcomes this and other disadvantages of the previous approaches.

In accordance with the teachings of the present invention, a computer-implemented method and system are provided for speech recognition of a user speech input. The user speech input contains a request that needs processing. The present invention creates dynamic sets of noise model with varying probabilities, in order to adjust the noise according to speech input, speech complexity, user profiles and background noise environment. More specifically, first noise probability model is applied to the user speech input at a first noise ratio level in order to recognize a first set of words in the user speech input. A second noise probability model is applied to the user speech input at a second noise ratio level in order to recognize a second set of words in the user speech input. The user's request is processed based upon which words are recognized in both the first set and second set of recognized words. Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a system block diagram depicting the computer and software-implemented components used by the present invention to recognize user input speech;

FIGS. 2 and 3 are flow charts depicting the operational steps used by the present invention to recognize user input speech;

FIG. 4 is a block diagram depicting the web summary knowledge database for use in speech recognition;

FIG. 5 is a block diagram depicting the conceptual knowledge database unit for use in speech recognition; and

FIG. 6 is a block diagram depicting the popularity engine database unit for use in speech recognition.

### DETAILED DESCRIPTION OF THE PREFERRED EMBODIMENT

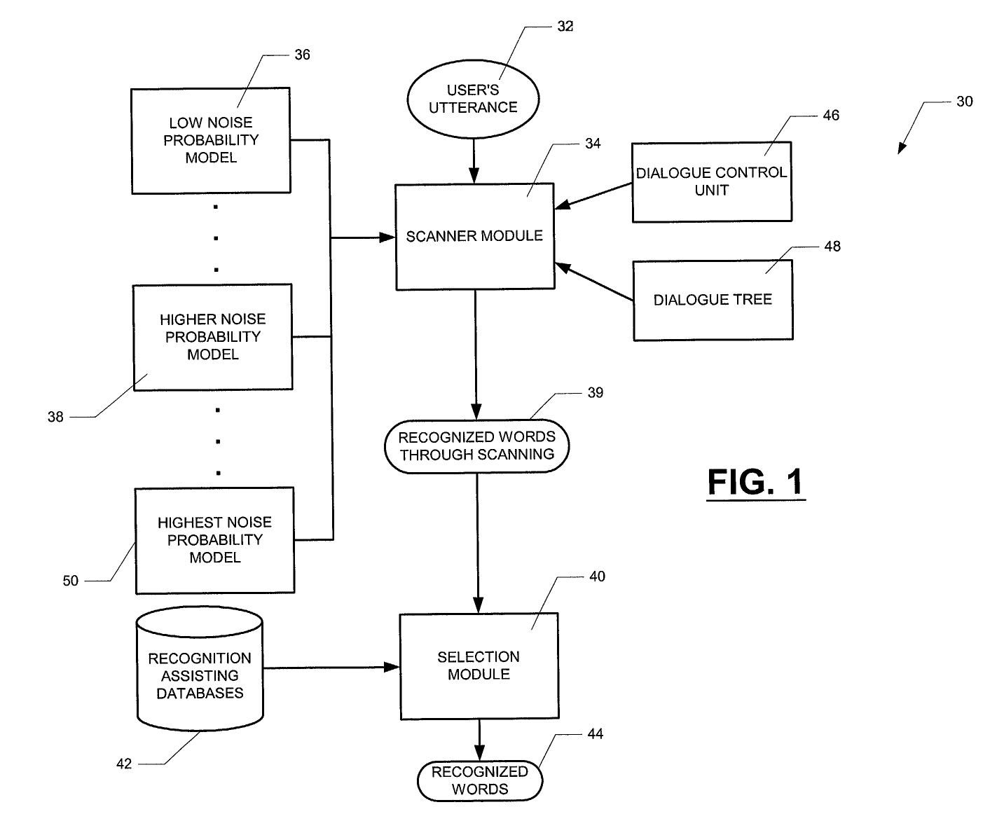

FIG. 1 depicts a progressive noise scanning system 30 that deploys multiple scans of the user's utterance 32 with progressively higher noise ratios. The progressive noise scanning system 30 eliminates “noise words” and background noise. Recognized words 39 are an input to a selection module 40 that accesses recognition assisting databases 42 to further hone the recognition of the user's utterance 32.

The present invention uses a scanner module 34 to scan the user input utterance 32 via a low noise probability model 36. The low noise probability model deploys a noise to word probability ratio of 1.0, thereby allowing most words to be recognized. It analyzes noise level detection and distinguishes noise from sound in the user's utterance 32. It accesses information from a dialogue control unit 46 and a dialogue tree 48 to use as a reference for non-noise sounds and for distinguishing between the request and background noise, and between distinct and indistinct words. The dialogue control unit 46 and dialogue tree 48 are used to track the dialogue between a user and a service-providing process. It uses linguistic rules to determine the action required in response to an utterance. The dialogue control unit provides information, which determines the type of noise words, noise phonemes and probability for all subsequent scanning activities. For example, a dialog tree model with Amazon.com contains different sets of language model, according to the depth and specificity of the conversation. The dialog control unit sends such information to the scanning module, which dynamically generates the number of noise scanning, noise model compositions, size as well as the associated probabilities.

Next, the scanner module 34 uses a higher noise probability model 38 to scan the user's utterance 32 with a higher noise to word probability ratio, thereby recognizing fewer words. A highest noise probability model 50 then scans the user's utterance 32 with the highest noise to word probability ratio, thereby eliminating the most words. Noise probability models are generally discussed in the following reference . “Robustness in Automatic Speech Recognition: Fundamentals and Applications”, Jean Claude Junqua and Jean-Paul Haton, Kluwer Academic Publishers, 1996, pages 155-191.

The selection module 40 accumulates the recognized words 39 from the progressive noise probability models, assessing a higher weighting for words that have been recognized consistently throughout the scanning process. The selection module 40 also uses recognition assisting databases 42 to further refine the recognition results 39. For example, recognition assisting databases 42 utilize a web summary knowledge database that contains formulae to allow predictions about what terms are likely to be found in the user request, helping to eliminate falsely recognized words. The recognition assisting databases 42 also use dialogue relevance information to allow some recognized words to be eliminated as noise based on contextual cues or if the word is not included in the application corpus. A user preference information from a popularity database can predict the probability of certain words in the user request based on user history and deploy this experience to reduce false recognition. Conceptual knowledge from a conceptual knowledge database facilitates comprehension of the user request, and helps the elimination of incorrect recognitions based on context and associative logic.

The following example illustrates the teachings of the present invention. In this example, a user makes the request, “I want to buy an audio player.” The low noise probability model 36 scans the utterance and detects, “I want two fly an audio player.” The original utterance is rescanned by the higher noise probability model 38. The higher noise model 38 detects fewer words and eliminates more noise, resulting in “buy two audio auto player.” The third model 50 scans with the highest noise probability and detects “buy audio player.” Based on predictions from web based information, dialogue relevance information, user preference, and conceptual information, the selection module 40 analyses the multiple scans and arrives at “buy audio player,” leading to an appropriate processing of the response.

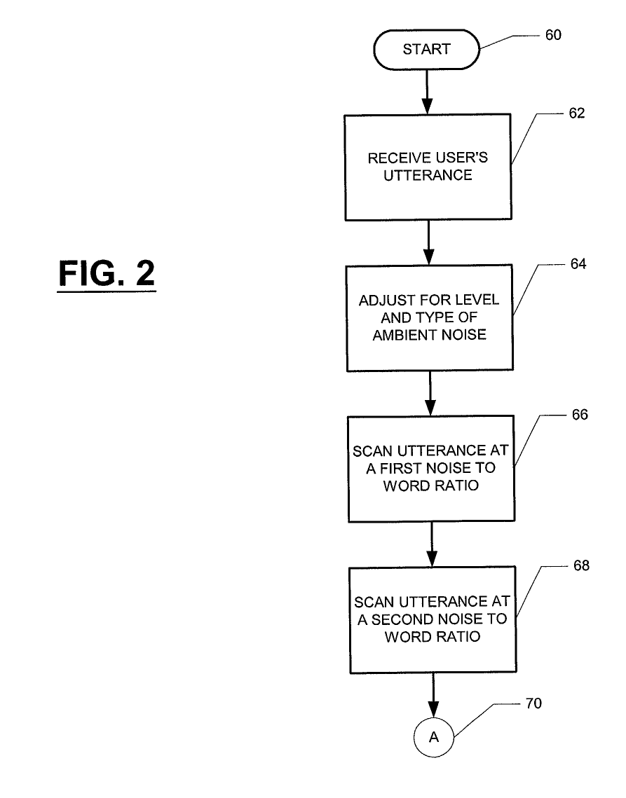

FIG. 2 depicts an operational sequence for the present invention. With reference to FIG. 2, start block 60 indicates that process block 62 is performed wherein the user's utterance is received for processing. Process block 64 dynamically adjusts for the level and type of ambient noise behind the user's utterance by normalizing the noise level along with predefined noise scanning models. At process block 66, the user's input utterance is scanned through the low noise probability model where words are analyzed for bi-phoneme noise, tri-phoneme noise, bi-gram noise, and tri-gram noise, and other elements of noise composition (such as human sound, background noise, acoustic noise models, noise words and phrases).

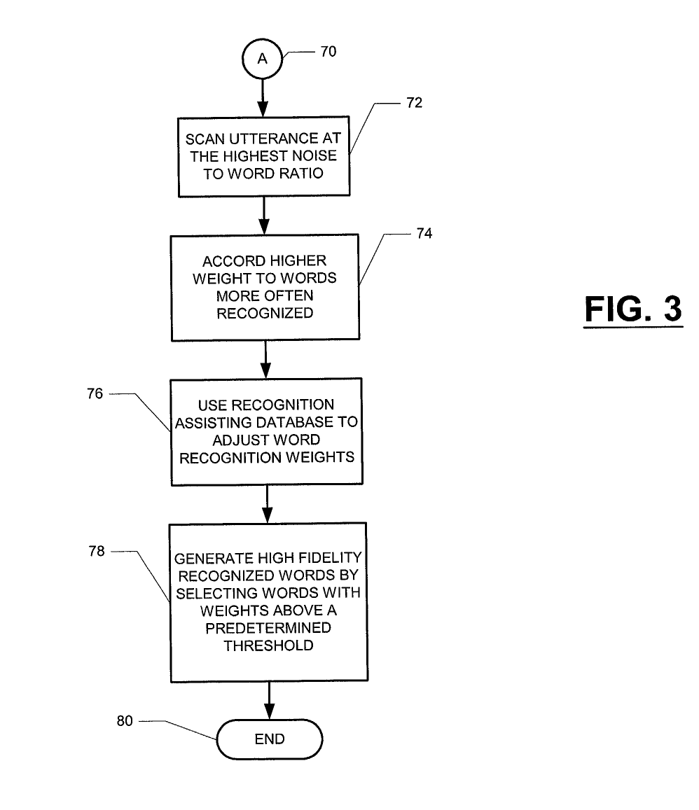

The low noise probability model typically yields an almost complete utterance with very few words eliminated as noise. A distinct word is given a higher probability weighting than an indistinct or garbled word. Next at process block 68, the utterance is processed through a higher noise probability model with a higher noise to word probability ratio. This process yields fewer recognized words. Processing continues on FIG. 3 as indicated by continuation block 70.

With reference to FIG. 3, process block 72 uses the highest noise probability model to scan the utterance with a yet higher noise to word probability ratio, and the results contain even fewer recognized words. The results from each scan accumulate in the selection module. At process block 74 words receive a greater weighting for accuracy if they have been recognized correctly at each level of noise probability. This process allows the selection module to determine a more precise probability of correct recognition for each word.

The selection module may access the recognition assisting databases to further eliminate incorrectly recognized words and words not contained in the application vocabulary as shown by process block 76. For example, web-based information from the web summary knowledge database influences the word probabilities by indicating the relative probabilities of recognized terms being relevant based on word usage on Internet web pages. Similarly, the specific individual user's history from the popularity database influences the predicted relevance of recognized words based on data from pooled user histories. Dialogue relevance information facilitates the elimination of falsely recognized words by discarding terms that are contextually inappropriate. Conceptual knowledge from the conceptual knowledge database uses logical rules to ensure the coherence of the decoded user utterance.

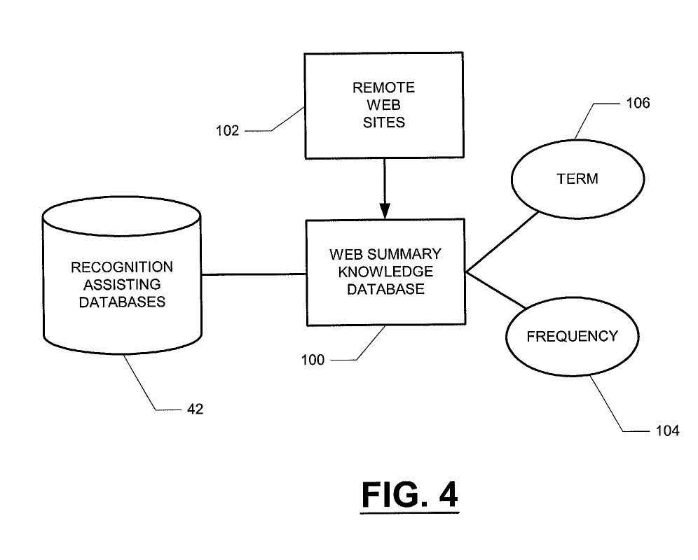

FIG. 4 depicts the web summary knowledge database 100. The web summary information database 100 contains terms and summaries derived from relevant web sites 102. The web summary knowledge database 100 contains information that has been reorganized from the web sites 102 so as to store the topology of each site 102. Using structure and relative link information, it filters out irrelevant and undesirable information including figures, ads, graphics, Flash and Java scripts. The remaining content of each page is categorized, classified and itemized. Through what terms are used on the web sites 102, the web summary database 100 determines the frequency 104 that a term 106 has appeared on the web sites 102. For example, the web summary knowledge database 100 may contain a summary of the Amazon.com web site and determines the frequency that the term golf appeared on the web site.

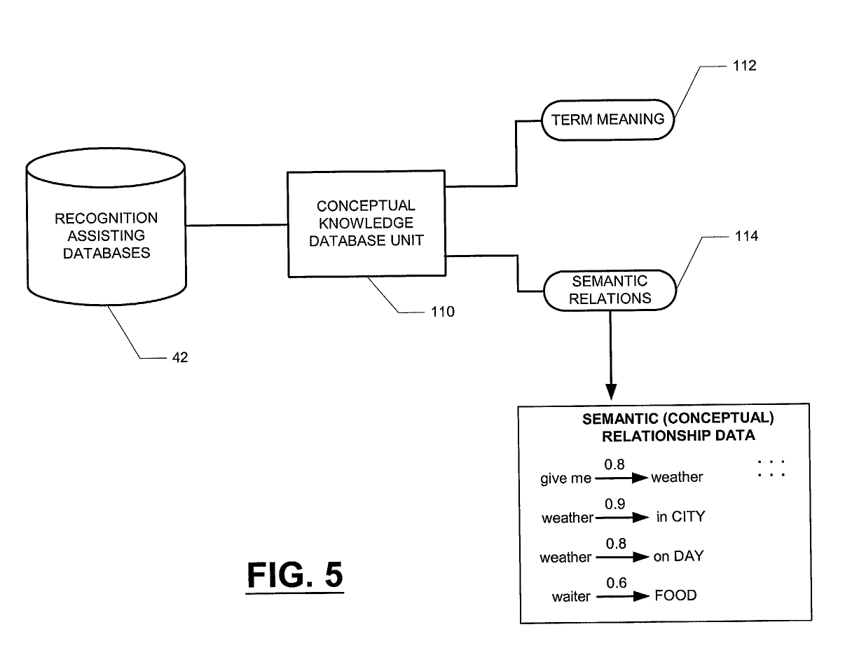

FIG. 5 depicts the conceptual knowledge database unit 110. The conceptual knowledge database unit 110 encompasses the comprehension of word concept structure and relations. The conceptual knowledge unit 110 understands the meanings 112 of terms in the corpora and the semantic relationships 114 between terms/words.

The conceptual knowledge database unit 110 provides a knowledge base of semantic relationships among words, thus providing a framework for understanding natural language. For example, the conceptual knowledge database unit may contain an association (i.e., a mapping) between the concept “weather” and the concept “city”. These associations are formed by scanning web sites, to obtain conceptual relationships between words and categories, and by their contextual relationship within sentences.

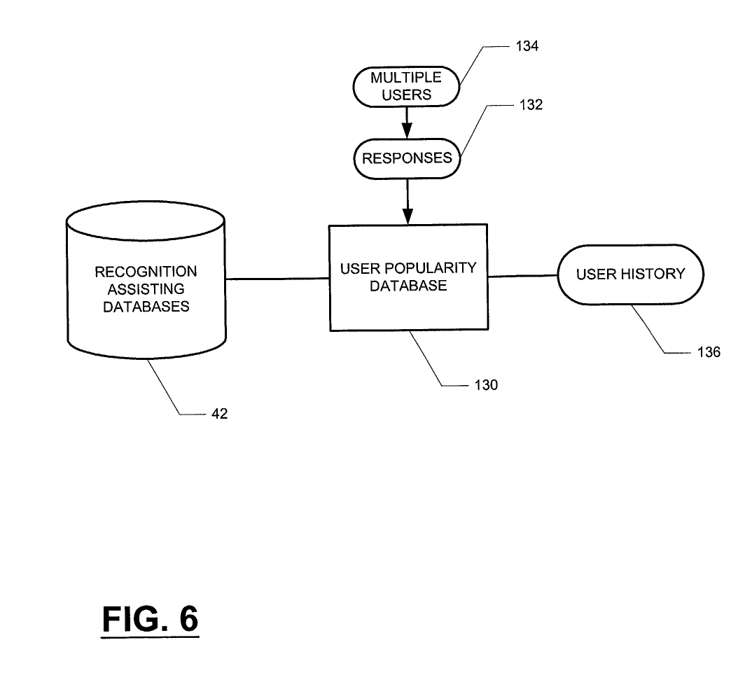

FIG. 6 depicts the popularity database 130 that forms one of the recognition assisting databases 42. The popularity database 130 contains data compiled from multiple users' histories that has been calculated for the prediction of likely user requests. The histories are compiled from the previous responses 132 of the multiple users 134. The response history compilation 136 of a specific user (whose request is being processed by the present invention) is also stored in the popularity database 130. This database makes use of the fact that users typically belong to various user groups, distinguished on the basis of past behavior, and can be predicted to produce utterances containing keywords from language models relevant to, for example, shopping or weather related services.

The preferred embodiment described within this document is presented only to demonstrate an example of the invention. Additional and/or alternative embodiments of the invention will be apparent to one of ordinary skill in the art upon reading this disclosure.

It is claimed:

1. A computer-implemented method for speech recognition of a user speech input, comprising the steps of:
receiving the user speech input in order to recognize and process a request contained in the user speech input;
applying a first noise probability model to the user speech input at a first noise ratio level in order to recognize a first set of words in the user speech input;
applying a second noise probability model to the user speech input at a second noise ratio level in order to recognize a second set of words in the user speech input; and
processing the request based upon which words are recognized in both the first set and second set of recognized words.
